(19) United States
(12) Patent Application Publication
(10) Pub. No.: US 2007/0159476 A1
(43) Pub. Date: Jul. 12, 2007

(54) Method for creating a stereoscopic image master for imaging methods with three-dimensional depth rendition and device for displaying a steroscopic image master

(76) Inventor: Armin Grasnick, Jena (DE)

Correspondence Address: BODNER & O'ROURKE, LLP, 425 BROADHOLLOW ROAD, SUITE 108, MELVILLE, NY, 11747, US

(21) Appl. No.: 10/572,025

(22) PCT Filed: Aug. 25, 2004
(86) PCT No.: PCT/EP04/09480

§ 371 Date: Sep. 29, 2006

(30) Foreign Application Priority Data
Sep. 15, 2003 (DE) 10342465.2
Oct. 20, 2003 (DE) 10348618.6

(51) Int. Cl. G06T 15/00

(52) U.S. Cl. 345/419

(57) ABSTRACT

The invention relates to a method for production of three-dimensional image patterns from two-dimensional image data, in particular from image data from image sequences, video films and the like. In this case, a virtual three-dimensional image framework (307) which is based on a supposition-based three-dimensional image depth graduation is generated on the basis of image information of imaged objects (303, 304, 305, 306) determined from monocular original image data, in which case the original image data is matched to the virtual three-dimensional image framework (307) in order to generate a virtual three-dimensional image model, and a range of individual images, which image the virtual three-dimensional image model, are obtained from the virtual three-dimensional image model. The virtual individual images are combined in a combination step to form a three-dimensional image pattern in order to carry out an imaging method with an additional depth effect.

The invention relates to a method for production of a three-dimensional image pattern according to the precharacterizing clause of Claim 1, and to an apparatus for displaying a three-dimensional image pattern according to the precharacterizing clause of Claim 16.

Three-dimensional objects are imaged only two-dimensionally by monocular recording devices. This is because these objects are recorded from a single observation location and from only one observation angle. In the case of a recording method such as this, the three-dimensional object is projected onto a film, a photovoltaic receiver, in particular a CCD array, or some other light-sensitive surface. A three-dimensional impression of the imaged object is obtained only when the object is recorded from at least two different observation points and from at least two different viewing angles, and is presented to a viewer in such a way that the two two-dimensional monocular images are perceived separately by the two eyes, and are joined together in the physiological perception apparatus of the eyes. For this purpose, the monocular individual images are combined to form a three-dimensional image pattern, leading to a three-dimensional image impression for the viewer using an imaging method which is suitable for this purpose. Methods such as these are also referred to as an “anaglyph technique”.

A three-dimensional image pattern which can be used for a method such as this can be provided or produced in various ways. The known stereo slide viewers should be mentioned here as the simplest example, in which the viewer uses each eye to view in each case one image picture recorded from a different viewing angle. A second possibility is for the image that is produced from the first viewing angle to be coloured with a first colour, and for the other image, which is photographed from the second viewing angle, to be coloured with a second colour. The two images are printed on one another or are projected onto one another in order to create a three-dimensional image pattern with an offset which corresponds to the natural viewing angle difference between the human eyes or the viewing angle difference in the camera system, with the viewer using two-coloured glasses to view the image pattern. In this case, the other viewing angle component is in each case filtered out by the correspondingly coloured lens in the glasses. Each eye of the viewer is thus provided with an image which differs in accordance with the different viewing angle, with the viewer being provided with a three-dimensional impression of the image pattern. A method such as this is advantageous when data from a stereocam is intended to be transmitted and displayed in real time and with little hardware complexity. Furthermore, simulated three-dimensional images are also displayed by means of a method such as this for generation of a three-dimensional image pattern, with the viewer being able to obtain a better impression of complicated three-dimensional structures, for example complicated simulated molecule structures and the like.

Furthermore, physiological perception apparatus mechanisms which have a subtle effect can be used to generate the three-dimensional image pattern. For example, it is known for two images which are perceived shortly one after the other within the reaction time to be combined to form a subjective overall impression. If two image information items are accordingly transmitted shortly after one another as a combined three-dimensional image pattern, respectively being composed of recordings which have been made from the first and the second viewing angle, these are joined together in the viewer's perception to form a subjective three-dimensional overall impression, using shutter glasses.

However, all of the methods that have been mentioned have the common feature that at least one binocular record of the three-dimensional image picture must be available in advance. This means that at least two records, which have been made from different viewing angles, must be available from the start or must be produced from the start (for example in the case of drawings). Images or films, video sequences and images such as these which have been generated in a monocular form from the start and thus include only monocular image information can accordingly not be used for a three-dimensional display of the object. By way of example, a photograph which has been recorded using a monocular photographic apparatus is a two-dimensional projection without any three-dimensional depth. The information about the three-dimensional depth is irrecoverably lost by the monocular imaging and must be interpreted by the viewer on the basis of empirical values in the image. However, of course, this does not result in a real three-dimensional image with a depth effect.

This is disadvantageous to the extent that, in the case of an entire series of such two-dimensional records that have been generated in a monocular form, a considerable proportion of the original effects and of the information in the image picture is lost. The viewer must think of this effect on information or must attempt to explain this to other viewers in which case, of course, the original impression of a three-dimensional nature cannot be recovered with any of the three-dimensional imaging methods in the examples mentioned above.

The object is therefore to specify a method for production of three-dimensional image patterns from two-dimensional image data, in particular of image data from image sequences, video films and information such as this, in which a three-dimensional image pattern is generated from a two-dimensional record, for an imaging method with a three-dimensional depth effect.

This object is achieved by a method according to the features of Claim 1, with the dependent claims containing at least refining features of the invention.

In the following description, the expression the “original image” means the originally provided two-dimensional image, produced in a monocular form. It is immediately evident that the method according to the invention as described in the following text can also be applied to sequences of original images such as these, and can thus also be used without any problems for moving images, in particular video or film records, provided that these comprise a series of successive images, or can be changed to such a series.

According to the invention, a virtual three-dimensional image framework which is based on a supposition-based image depth graduation is generated on the basis of image information of imaged objects determined from monocular original image data. The original image data is matched to the virtual three-dimensional image framework in order to generate a virtual three-dimensional image model. The data of the virtual three-dimensional image model is used as a pattern for production of the three-dimensional image pattern for the imaging method with a three-dimensional depth effect.

Thus, according to the invention, the objects imaged on the two-dimensional image are determined first of all. A supposition about their three-dimensional depth is then associated with each of these objects. This results in a virtual three-dimensional model, in which the original image data from the two-dimensional image is matched to this virtual three-dimensional model. This virtual three-dimensional model now forms a virtual object, whose data represents the point of origin for generation of the three-dimensional image pattern.

A method for edge recognition of the imaged objects with generation of an edge-marked image is carried out on the monocular original image data in order to determine the image information. During this process, in the case of the supposition-based image depth graduation, original image areas are associated on the basis of a determined multiplicity of edges with different virtual depth planes, in particular with a background and/or a foreground.

This makes use of the discovery that objects with a large amount of detail and thus with a large number of edges are in general associated with a different image depth, and thus a different depth plane, than objects with little detail and thus also with few edges. The step of edge recognition accordingly sorts out components of the original image from which it can be assumed that these are located in the background of the image, and separates them from those which can be assumed to be in the foreground or a further depth plane.

In a further procedure for determination of the image information, a method for determination of the colour information of given original image areas is carried out. In this case, in the case of the supposition-based image depth graduation, at least one first identified colour information item is associated with a first virtual depth plane, and a second colour information item is associated with a second virtual depth plane.

In this case, use is made of the empirical fact that specific colours or colour combinations in certain image pictures preferably occur in a different depth plane than other colours or colour combinations. Examples of this are blue as a typical background colour in the case of landscapes on the one hand, and red or green as typical foreground colours of the imaged picture, on the other hand.

The method for edge recognition and the method for determination of the colour information can be used both individually and in combination with one another, in which case, in particular, combined application of edge recognition and determination of the colour information allows further differentiation options for the original image data, in particular finer definition of further depth planes.

In one expedient refinement, a soft drawing method is applied to the edge-marked image for amplification and for unifying an original image area which is rich in edges. On the one hand, this thus compensates for possible errors in the edge recognition, while on the other hand amplifying structures which are located alongside one another, and are not randomly predetermined. The values of the edge-marked image can optionally and additionally be corrected for tonal values.

A relevant image section is associated, based on the tonal value of one pixel, with a depth plane on the basis of the soft-drawn and/or additionally tonal-value-corrected, edge-marked image. The structures of the edge-marked image which has been softly drawn and optionally corrected for tonal values are now associated with individual defined depth planes, depending on their tonal value. The edge-marked, soft-drawn and optionally tonal-value-corrected image thus forms the base for unambiguous assignment of the individual image structures to the depth planes, for example to the defined virtual background, a virtual image plane or a virtual foreground.

The colour and/or tonal values are limited to a predetermined value for a fix point definition process, which is carried out in this case. A virtual rotation point is thus defined for the individual views that are to be generated subsequently. In this case, the selected colour and/or tonal value forms a reference value, which is associated with a virtual image plane and thus separates one virtual depth background from a foreground which virtually projects out of the image plane.

The assignment of a virtual depth plane can be carried out in various ways. The already described method steps expediently indicate association of a depth plane with a respectively predetermined colour and/or brightness value of an image pixel. Objects with image pixels which thus have the same colour and/or brightness values are thus associated with one depth plane.

As an alternative to this, it is also possible to associate arbitrarily defined image sections, in particular an image edge and/or the image center, with one virtual depth plane. This results in particular in virtual “curvature”, “twisting”, “tilting” and similar three-dimensional image effects.

In order to generate the virtual three-dimensional image model, the virtual three-dimensional image framework is generated as a virtual network structure deformed in accordance with the virtual depth planes, and the two-dimensional original image is matched, as a texture, to the deformed network structure using a mapping method. The network structure in this case forms a type of virtual three-dimensional “matrix” or “profile shape”, while the two-dimensional original image represents a type of “elastic cloth”, which is stretched over the matrix and is pressed into the matrix in the form of a virtual “thermoforming process”. The result is a virtual three-dimensional image model with the image information of the two-dimensional original image and the “virtual thermoformed structure”, which is additionally applied to the original image, of the virtual three-dimensional matrix.

Virtual binocular views or else multi-ocular views can be derived from this three-dimensional image model. This is done by generating a range of virtual individual images which reproduce the views of the virtual three-dimensional image model and in which those image sections of the original image which correspond to a defined depth plane are shifted and/or distorted in accordance with the virtual observation angle from a range of virtual observation angles from the virtual three-dimensional image model. The virtual three-dimensional image model is thus used as a virtual three-dimensional object which is viewed virtually in a binocular or multi-ocular form, with virtual views being obtained in this case which differ in accordance with the observation angles.

These virtual individual images are combined in order to generate a three-dimensional image pattern, using an algorithm which is suitable for the imaging method and has an additional three-dimensional effect. In this case, the virtual individual images are handled in the same way as individual images which have actually been recorded in a binocular or multi-ocular form, and are now suitably processed and combined for a three-dimensional display method.

Virtually obtained binocular or multi-ocular image information is thus available, which can be used for any desired three-dimensional imaging method.

In one embodiment of the method, individual image areas of the original image are processed in order to produce the three-dimensional image pattern, in particular with scaling and/or rotation and/or mirroring being carried out, and the three-dimensional image pattern which is generated in this way is displayed by means of a monofocal lens array located above it.

In this case, the image structures which are associated with specific depth planes in the virtual three-dimensional image model are changed such that they offer an adequate accommodation stimulus for the viewing human eye when the three-dimensional image pattern that has been generated in this way is displayed. The image structures which are emphasized in this way are perceived as being either in front of or behind the given image plane by means of the optical imaging through the lens array, and thus lead to a three-dimensional impression when the image is viewed. This method requires only a relatively simple three-dimensional image pattern in conjunction with a simple embodiment of the imaging method with a three-dimensional depth effect.

The two-dimensional original image can also be displayed directly without image processing by means of the monofocal lens array. The two-dimensional original image can thus be used immediately as a three-dimensional image pattern for display by means of the monofocal lens array. A procedure such as this is particularly expedient when simple image structures have to be displayed in front of a homogeneously structured background, in particular character in front of a uniform text background, with a depth effect. The accommodation stimulus which is achieved by the imaging effect of the monofocal lens array then results in a depth effect for the viewing eye, in which case the original image need not per se be processed in advance for such a display.

An apparatus for displaying a three-dimensional image pattern is characterized by a three-dimensional image pattern and a monofocal lens array arranged above the three-dimensional image pattern. The monofocal lens array in this case images areas of the three-dimensional image pattern and results in an appropriate accommodation stimulus in the viewing eye.

For this purpose, the two-dimensional image pattern is expediently formed from a mosaic composed of image sections which are associated with the array structure of the lens array, with essentially in each case one image section being an imaging object for essentially in each case one associated lens element in the monofocal lens array. The two-dimensional image pattern is accordingly subdivided into a totality of individual image areas, which are each displayed by one lens element.

In principle, two embodiments of the image pattern and in particular of the image areas are possible with this apparatus. In a first embodiment, the image sections are essentially unchanged image components of the two-dimensional image pattern of the original image. This means that, in the case of this embodiment, the essentially unchanged two-dimensional image forms the three-dimensional image pattern for the lens array. There is therefore no need for image processing of individual image areas in this embodiment, apart from size changes to or scaling of the entire image.

In a further embodiment, the image sections are scaled and/or mirrored and/or rotated in order to compensate for the imaging effects of the lens array. This results in a better image quality, although the effort involved in production of the three-dimensional image pattern increases.

The two-dimensional image pattern is, in particular, an image which is generated on a display, while the lens array is mounted on the surface of the display. The lens array is thus fitted at a suitable point to a display which has been provided in advance, for example a cathode ray tube or a flat screen, and is thus located above the image produced on the display. This arrangement can be implemented in a very simple manner.

In a first embodiment, the lens array is in the form of a Fresnel lens arrangement which is like a grid and adheres to the display surface. The use of Fresnel lenses ensures that the lens array has a flat, simple form, in which case the groove structures which are typical of Fresnel lenses can be incorporated in the manner known according to the prior art in a transparent plastic material, in particular a plastic film.

In a second embodiment, the lens array is in particular in the form of a flexible zone-plate arrangement which is like a grid and adheres to the display surface. A zone plate is a concentric system of light and dark rings which cause the light passing through it to be focussed by light interference, thus allowing an imaging effect. An embodiment such as this can be produced by printing a transparent flexible film in a simple and cost-effective manner.

In a third embodiment, it is also possible for the lens array to be in the form of an arrangement of conventionally shaped convex lenses, in which case, however, the thickness of the overall arrangement is increased, and thus also the amount of material consumed in it.

The method and the apparatus will be explained in more detail in the following text with reference to exemplary embodiments. The attached figures are used for illustrative purposes. The same reference symbols are used for identical method steps and method components, or those having the same effect. In the figures:

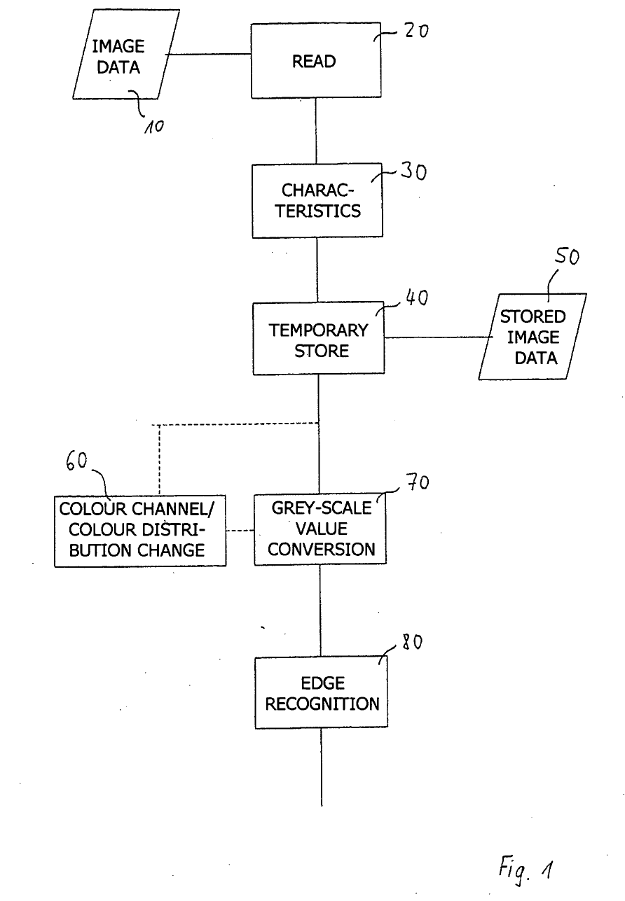

FIG. 1 shows a first part of an example of a schematic program flowchart of the method,

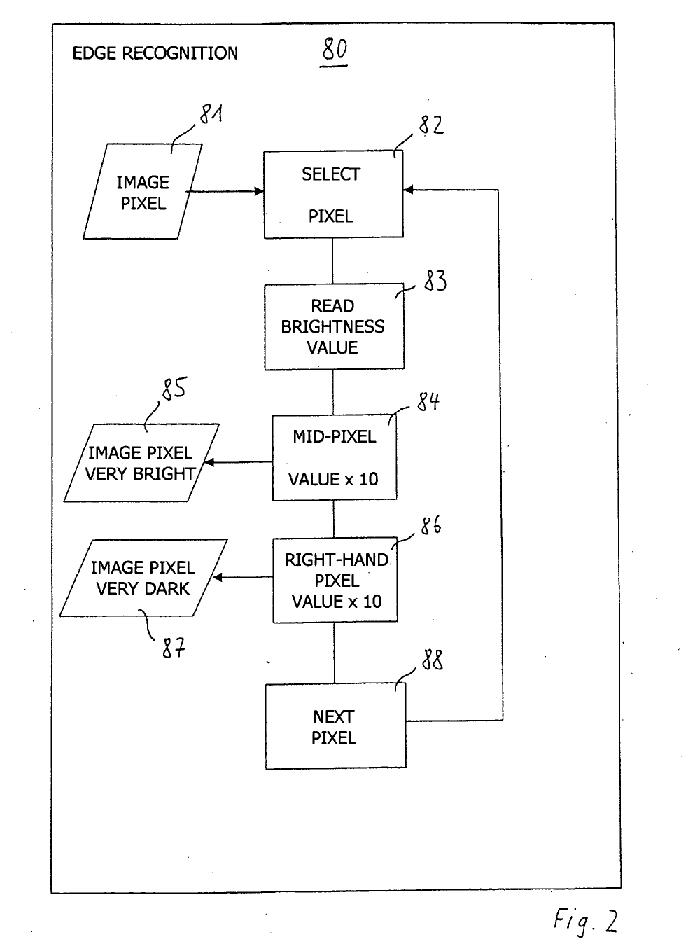

FIG. 2 shows an example of a flowchart for edge recognition,

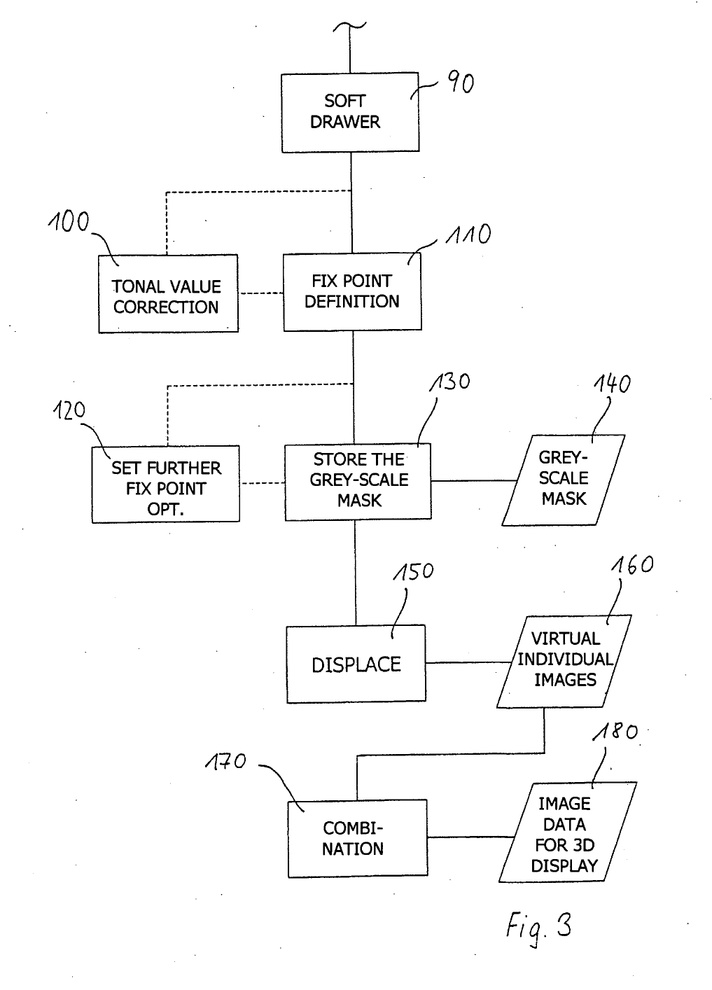

FIG. 3 shows a second part of an example of a schematic program flowchart of the method,

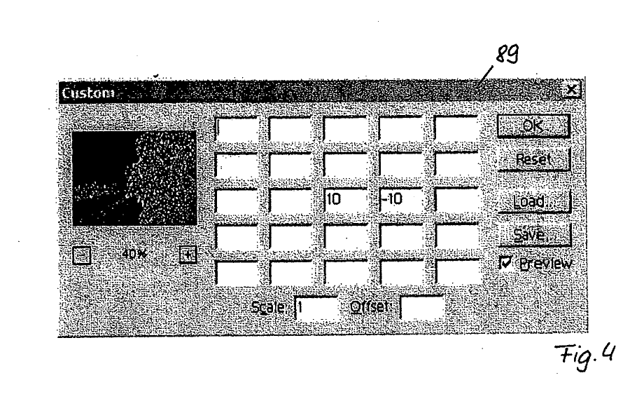

FIG. 4 shows an example of a selection menu for carrying out edge recognition,

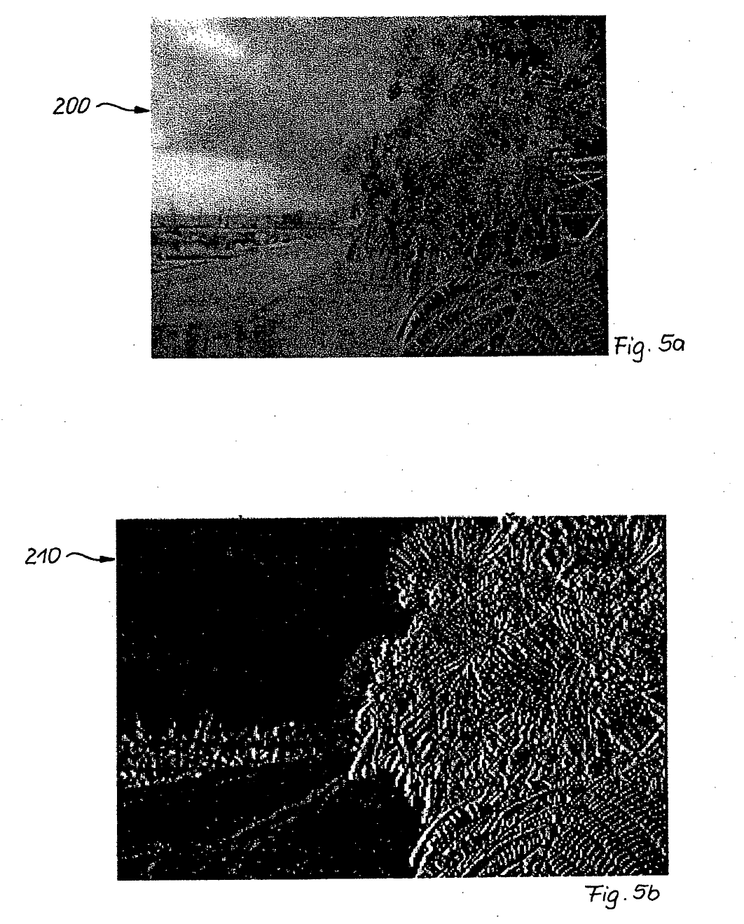

FIG. 5a shows an example of an original image,

FIG. 5b shows an example of an edge-marked image as the result of edge recognition being carried out on the example of an original image shown in FIG. 5a,

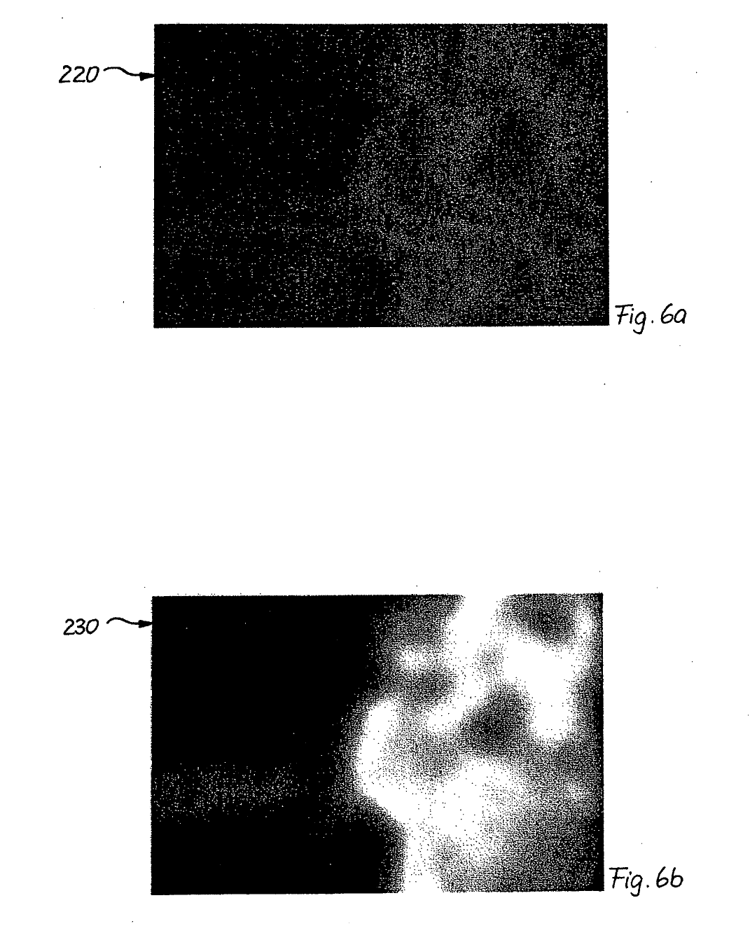

FIG. 6a shows an example of the result of soft drawing carried out on the edge-marked image shown in FIG. 5b,

FIG. 6b shows an example of the result of tonal-value correction carried out on the edge-marked image shown in FIG. 6a,

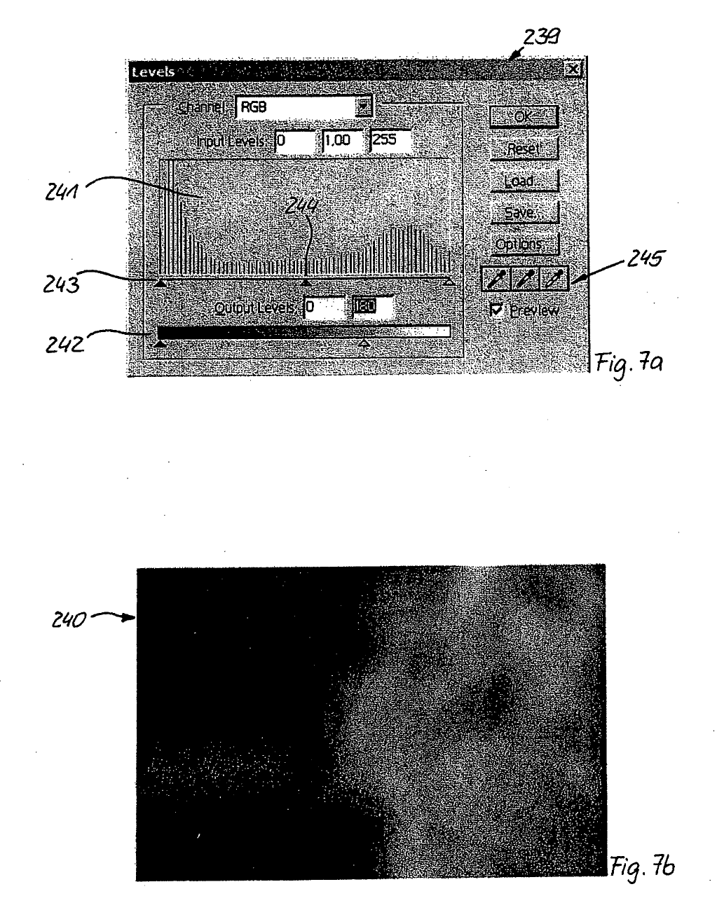

FIG. 7a shows an example of a selection menu for fix point definition,

FIG. 7b shows an example of a fix-point-defined image,

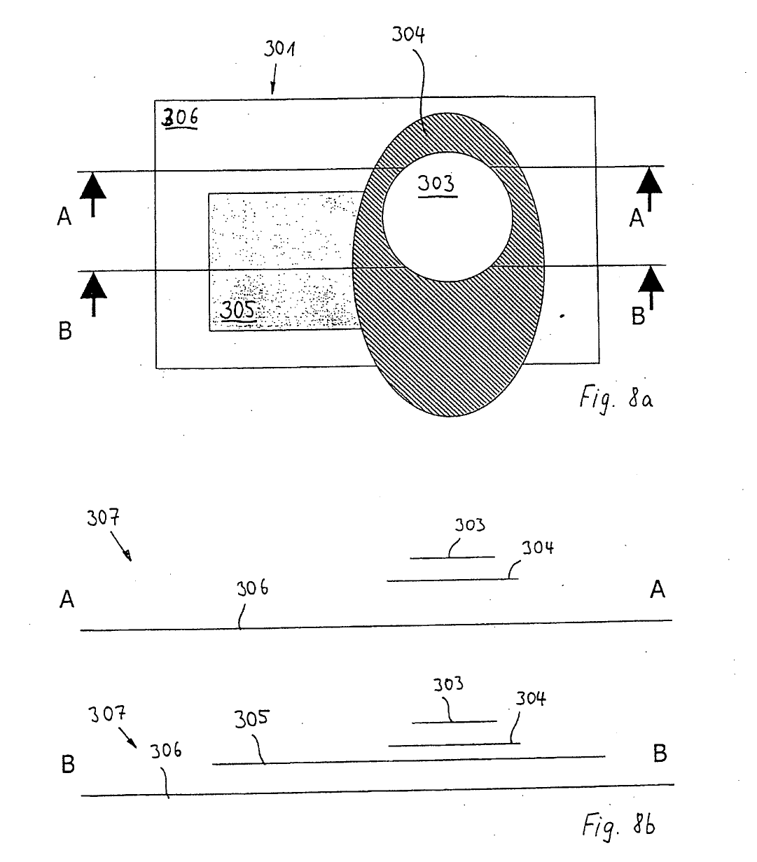

FIG. 8a shows a schematic example for graphical objects in a schematic two-dimensional original image,

FIG. 8b shows a schematic example of depth plane association for the graphical objects shown in FIG. 8a and generation of a virtual three-dimensional image model along examples of sections along the lines A-A and B-B from FIG. 8a,

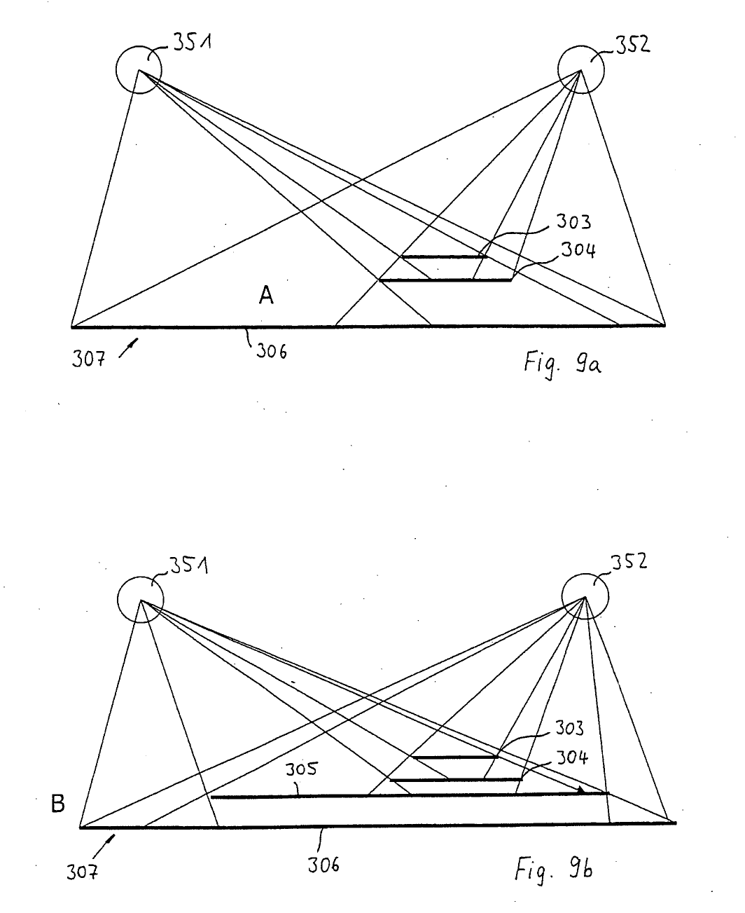

FIG. 9a shows a schematic example of a virtual binocular view and projection of the virtual three-dimensional image model along the line A-A from FIGS. 8a to 8b,

FIG. 9b shows a schematic example of an example of a virtual binocular view and projection of the virtual three-dimensional image model along the line B-B from FIGS. 8a and 8b,

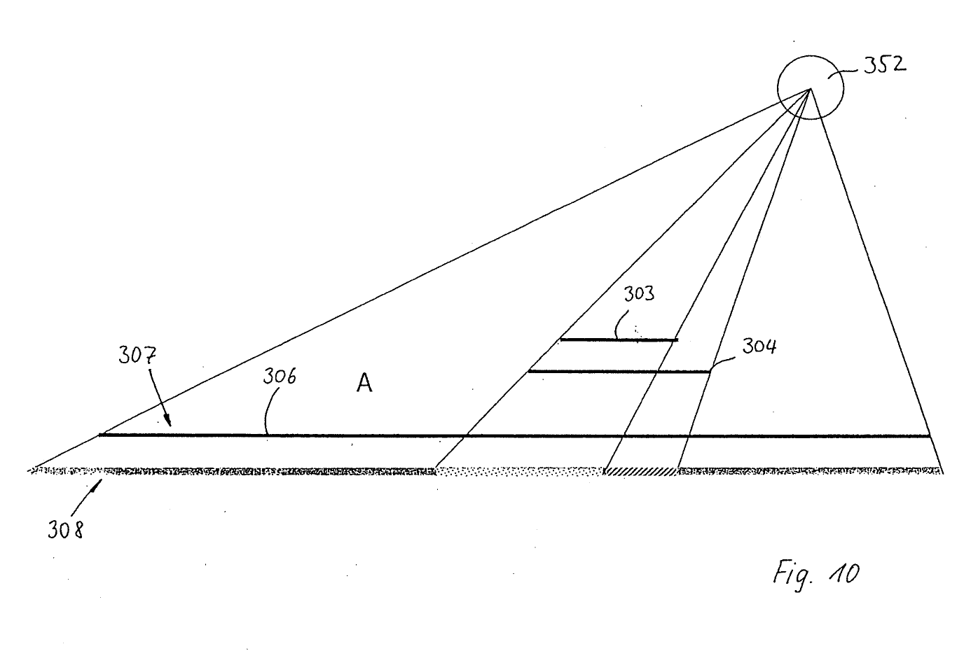

FIG. 10 shows a schematic example of virtual single-image generation from an example of a viewing angle along the example of the line A-A as shown in FIG. 9a,

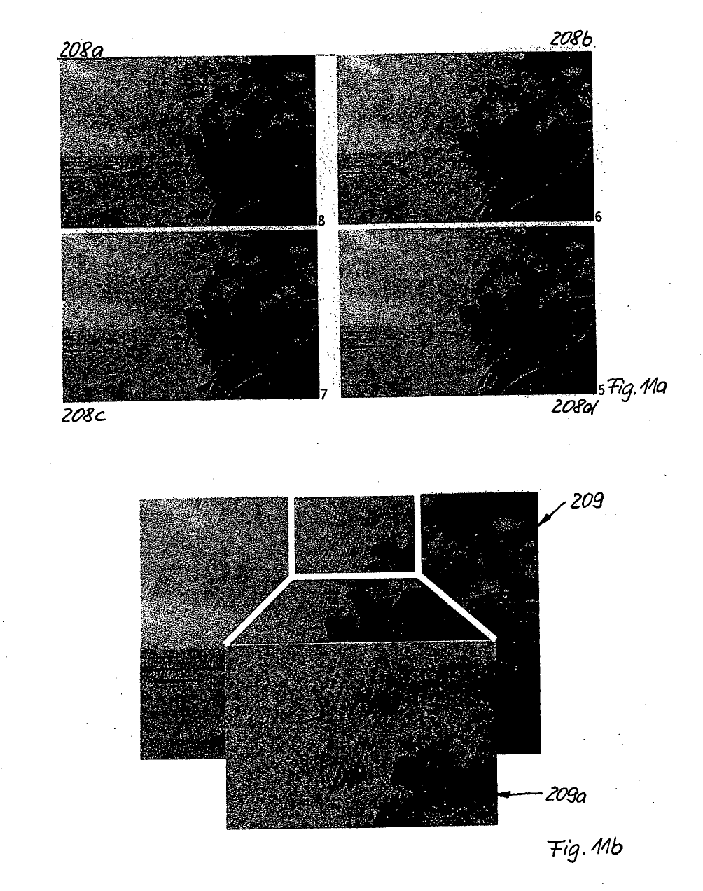

FIG. 11a shows a series of examples of virtual individual images of different viewing angles using the original image shown in FIG. 5a,

FIG. 11b shows an example of the combination of the virtual individual images shown in FIG. 11a, in an example of a three-dimensional image pattern for an imaging method with an additional depth effect,

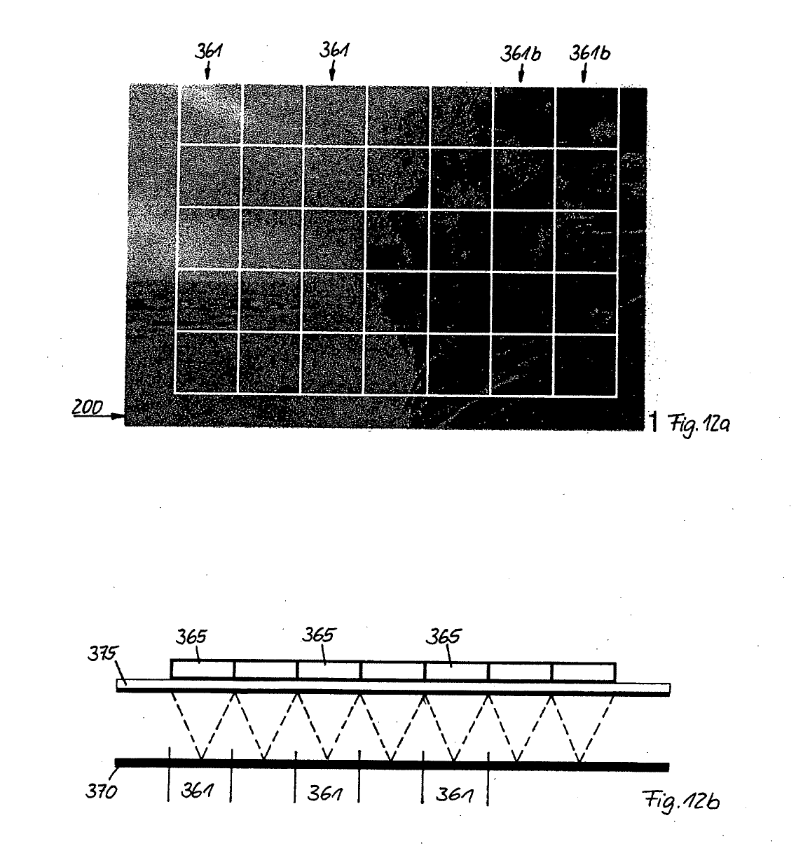

FIGS. 12a, b show examples of illustrations of a two-dimensional image pattern and of a monofocal lens array located above it, and

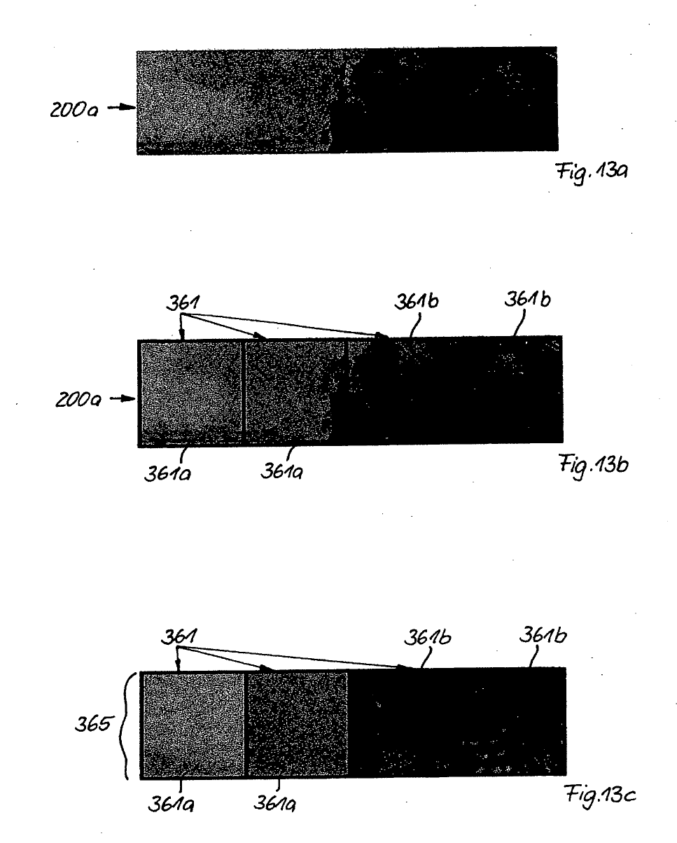

FIGS. 13a-c show examples of illustrations of an image of a two-dimensional image section by means of the monofocal lens array in the previous figures.

FIGS. 1 and 3 show, in two parts, an example of a schematic flowchart of the method. FIG. 2 explains an edge recognition method using a more detailed flowchart. FIGS. 4 to 11b show examples of the results and further details of the method according to the invention, as explained in the flowcharts.

The method starts from a set of original image data 10 of a predetermined two-dimensional, expediently digitized, original image. If the original image is an individual image as a component of an image sequence or of a digitized film, the following description is based on the assumption that all the other individual images in the image sequence can be processed in a manner corresponding to the individual image. The method as described by way of example in the following text can thus also be used for image sequences, films and the like.

It is expedient to assume that the original image data 10 is in the form of an image file, a digital memory device or a comparable memory unit. This data can be generated by the conventional means for generation of digitized image data, in particular by means of a known scanning process, digital photography, digitized video information and similar further known image production methods. In particular, this also includes image data which has been obtained by the use of so-called frame grabbers from video or film sequences. In principle, all known image formats can be used as data formats, in particular all the respective versions of the BMP-, JPEG-, PNG-, TGA-, TIFF- or EPS format. Although the exemplary embodiments described in the following text refer to figures which for presentation reasons are in the form of black and white images, or are in the form of grey-scale values, the original image data may also include colour information.

The original image data 10 is loaded in a main memory for carrying out the method, in a read step 20. In a method step of adaptation 30, the original image data is first of all adapted in order to carry out the method optimally. The adaptation 30 of the image characteristics comprises at least a change to the image size and the colour model of the image. Smaller images are generally preferred when the computation time for the method should be minimized. However, a change in the image size may also be a possible error source for the method according to the invention. In principle, the colour model to be adapted may be based on all the currently available colour models, in particular RGB and CMYK or grey-scale models, or else lab, index or duplex models, depending on the requirements.

The adapted image data is temporary stored for further processing in a step 40 for repeated access. The temporary stored image data 50 forms the basis of essentially all of the subsequent data operations.

Now, optionally, the temporary stored image data 50 is accessed either to change the colour channel/the colour distribution 60 or to change the image data to a grey-scale-graduated image by means of grey-scale graduation 70 as a function of the supposed three-dimensional image structure, that is to say the supposed graduation of the depth planes in the original image. The grey-scale graduation 70 is particularly advantageous when it can be assumed that depth information can predominantly be associated with the object contours represented on the image. In this case, all other colour information in the image is of equal relevance for depth interpretation of the original image, and can accordingly be changed to grey-scale values in the same way. Modification of the colour channel or of the colour distribution in the image data is expedient when it can be assumed that a colour channel is essentially a carrier of the interpreted depth information and should thus be stressed or taken into account in a particular form for the subsequent processing. In the case of the exemplary description of the method procedure provided here, it is assumed for improved presentation reasons, in particular with regard to the figures, that the temporary stored image data 50 is converted to grey-scale values independently of its colour values, with the colour information remaining unchanged.

As the method procedure continues, this is followed by edge recognition 80. This is based on the assumption that the depth planes interpreted into the two-dimensional original image are defined primarily by objects which are present in the image picture. For example, it can be assumed that highly structured objects, which are thus particularly pronounced by contours and thus edge-like structures will occur predominantly in the foreground of the image and that low-contour, blurred objects, which are thus low in edges, will form the image background. The edge recognition method 80 is carried out in order to unambiguously identify the different areas of the original image which on the basis of their structuring belong to different depth levels, and to unambiguously distinguish them from one, another as far as possible.

FIG. 2 shows a schematic example of a flowchart for edge recognition. FIG. 4, in conjunction with this, shows an example of an input menu 89 for definition of the changes to be carried out to the brightness values of a central pixel and a defined area around a pixel. The image pixels 81 which are defined by their grey-scales are processed continuously in a loop process. First of all, one pixel is selected 82, and its brightness value 83 is read. This brightness value is multiplied by a positive value that is as large as possible (in the example described here by the arbitrary value +10), thus resulting in a very bright image pixel 85 being produced. A brightness value of a pixel which is in each case located to the right of this is in contrast multiplied by a value which is a highly negative as possible (in the example described here by −10) in a step 86, as a result of which a very dark pixel 87 is produced. The next pixel is then read in a step 88. The edge recognition process results in an edge-marked image. Wherever the original image exhibits a multiplicity of structures and thus edges, the edge-marked image data that has now been produced comprises a structure of very bright and very dark pixels, while image areas which have little structure and thus have few contours and edges have a uniform dark colouring. The structure of the alternately very bright and very dark pixels and of the object marked in this way accordingly has a higher average brightness value than an area of continuously dark pixels.

Structures located alongside one another are then amplified by means of a method step 90, which is referred to as “soft drawing”. During this process, the brightness values of a specific selected set of pixels in the edge-marked image are averaged using a specific algorithm, and are assigned to the pixels in the selected set. A Gaussian soft-drawing method has been particularly proven for this purpose. The object structures are emphasized as a brighter set of pixels against the rest of the image parts in the soft-drawn, edge-marked image, and allow identification of a unit object.

Tonal value correction of the edge-marked, soft-drawn image can then be carried out, if required, in a step 100. During this process, the tonal values of the pixels are preferably corrected so as to produce contrast that is as clear as possible between the object structure and the remainder, which is defined as the background of the image.

The next method step is in the form of fix point definition 110. In this step, the colour values and/or grey-scales of the edge-marked soft-drawn image are limited to a specific value such that the virtual rotation point of the virtual individual views generated is, de facto, defined. In other words, the fix point definition 110 defines the objects or structures which are intended to be assumed to be located in a virtual form in front of or behind the image surface, and whose depth effect is thus intended to be imaged later.

Furthermore, further fix point options can optionally be taken into account in a method step 120. By way of example, a first supposition can first of all be applied, in which relatively large blue areas predominantly form a background (blue sky, water, etc.), while smaller, sharply delineated objects with a pronounced colour form the foreground of the image. In the same way, specific colour values can be associated with specific virtual depth planes from the start. For example, colour values which correspond to the colour of a face are associated with a virtual depth plane which corresponds to a medium image depth. In the same way, defined image sections, such as the image edge or the image center, may be associated with specific depth planes, for example with the foreground or the background, during which process it is possible to generate “twisting” or “curvature” of the three-dimensional image which will be produced later.

The graduations of the virtual depth planes generated in this way result in a virtual three-dimensional image framework which is used as a distortion mask or “displacement map” and can be visualized in the form of a grey-scale mask. This virtual three-dimensional image framework is stored in a step 130 for further use.

The virtual three-dimensional image framework is used as a distortion mask and virtual shape for generation of a virtual three-dimensional image model. In this case, in a method step 150 which is referred to in FIG. 3 as “displace”, the original image is placed as a texture over the virtual image framework and is distorted such that the corresponding original image sections are “thermoformed” onto the virtual depth planes, that is to say they are associated with the depth planes. Correspondingly known perspective imaging rules are now produced from this virtual three-dimensional image model, from a series of different virtual viewing angles, from virtual individual images 160 of the virtual three-dimensional image model, by virtual projection of the image data of the virtual three-dimensional image model.

In a combination step 170, the virtual individual images are combined using an algorithm that is defined for the imaging method with an additional depth effect, such that, finally, image data 180 is produced for three-dimensional imaging of the initial original image.

A number of image processing activities will be explained in more detail in the following text with reference to examples. FIG. 5a shows an, in general colour, two-dimensional original image 200. As can be seen from the image, a row of plants is obviously located in the foreground of the image picture, while unclear port installations, buildings and a largely unstructured beach can obviously also be seen in the background. Furthermore, the background, which extends virtually to infinity in the original image 200, is formed by a sky with a soft profile. As can be seen from FIG. 5a, the plants which are arranged in the obvious foreground are distinguished by having a considerable wealth of detail in comparison to the background, which is evident inter alia from a large number of “edges”, for example in the area of the leaves or of the flowers. The background has few edges, or no edges, in comparison to this. It is accordingly obvious to use the density of the edges in the original image 200 as an indicator for the three-dimensional position of the illustrated objects.

FIG. 5b shows an edge-marked image 210 which was obtained from the original image 200 after grey-scale conversion and optional size correction. Wherever the plants, which are rich in structure, are located in the original image 200 shown in FIG. 5a, the edge-marked image 210 has a large number of edges which are marked by light pixels, and lead to a higher mean image brightness, particularly in the right-hand image area. In contrast, both the sky and the beach area in the original image 200 have few edges and are thus predominantly dark in the edge-marked image 210, while the buildings which can be seen in the original image 200 produce a number of minor edge structures in the form of individual bright pixels.

FIGS. 6a and 6b show a soft-drawn edge-marked image 220 and a soft-drawn edge-marked image 230 that additionally has tonal value correction. As can be seen from the soft-drawn image 220, the right-hand image part differs from the left-hand image part by having a higher image brightness value. This difference is even more clearly evident in the image 230, with a tonal value correction, in FIG. 6b. The large number of edges in the area of the plants in the original image, in other words the wealth of structure in the assumed foreground, are clearly evident as a bright area in the images 220 and 230. The image 230, with tonal value correction, has a clearly somewhat brighter strip in the left-hand image half, although this is considerably darker than the image area of the plants. This strip corresponds to the imaged buildings from the original image 200 shown in FIG. 5a. The clearly darker brightness value indicates that the structure of the imaged buildings has fewer edges, and thus that it is arranged in the assumed image background.

The sky and the beach from the original image 200 form a uniformly dark area in the soft-drawn image with tonal value correction. Although the beach should in fact be associated with the central foreground of the image rather than with the background formed by the sky, its central foreground position cannot be clearly determined solely from the edge-marked, soft-drawn image with tonal value correction. In this case, the beach can be associated with a virtual central depth plane on the basis of the yellow or brown colour value, which in this example is clearly different from the colour value of the blue sky.

This can be done by the fix point definition 110 that has already been mentioned above. FIG. 7a shows an example of a menu 239 relating to this, and FIG. 7b shows the image 240 corresponding to the menu. A series of colour channels are shown in a histogram 241, and comprise a series of grey-scale values in the exemplary embodiment shown in FIG. 7a. The corresponding grey-scale values are indicated in a grey-scale value strip 242. The dark brightness values are located in the left-hand part of the histogram 241 and of the grey-scale value strip 242, and the light brightness values are in the right-hand part. The size of the histogram bars indicates the probability distribution of the corresponding grey-scale values. As can be seen, the bright area of the soft-drawn image 220 or 230 with tonal value correction has a broad maximum in the histogram 241, while the dark areas in the images 220 and 230 lead to a maximum in the left-hand part of the histogram 241 for the dark brightness values. Specific brightness values can be selected by means of indicator pointers 243. Brightness values of selected pixels can be read directly from the image 241 and transferred to the histogram 241 by means of the keys 245.

In the example described here, it is evident that the area which corresponds to the beach from the original image 200 has a different brightness value to that of the image section which corresponds to the sky from the original image 210. This can be selected as a virtual image plane by means of a selection indicator 244, and forms a possible fix point for virtual individual views of the virtual three-dimensional image model which is intended to be produced later.

FIGS. 8a and 8b use a very highly schematic example to show depth plane association and the design of a virtual three-dimensional image framework. FIG. 8a shows a highly schematic two-dimensional original image 310, produced in a monocular form, whose individual objects are assumed to have been identified in terms of their three-dimensional position in the image just by the contour recognition methods described above. The schematic original image 301 illustrated by way of example in FIG. 8a has a first object 303, a second object 304 and a third object 305, which are arranged in front of a surface 306, which is identified as background, and are raised from it.

The methods described above for contour marking, for fix point definition and further suppositions relating to the image depth make it appear to be worthwhile in an exemplary manner for the schematic original image 301 shown in FIG. 8a to arrange the first object 303 in the depth plane in the foreground, while the objects 304 and 305 should be associated with supposed depth planes in the image background. The area 306 forms an image background located effectively at infinity. FIG. 8b shows the virtual image framework 307 that is generated from the association of the objects from FIG. 8a with the corresponding depth planes, in a section along the lines A-A and the line B-B from FIG. 8a. The sections along the section lines A-A and B-B thus result in a virtual “height profile” of the virtual image framework. As can be seen from FIG. 8b, the object 303 is arranged on the uppermost depth plane in this virtual “height profile”, while the object 304 is associated with a depth plane located below this. The object 305 forms a further depth plane in the virtual image framework in FIG. 8b. The virtual depth plane of the image background 306 in FIG. 8b is arranged, for illustrative reasons, relatively close to the depth planes of the other objects 303, 304 and 305. An expedient virtual image framework must expediently have depth plane graduations which correspond to the supposed actual three-dimensional position of the objects. The virtual depth plane of the image background should accordingly expediently be arranged such that its distance from the other defined depth planes in the virtual image framework corresponds to a multiple of the distances between each of the others. If, for example, the distances between the virtual depth planes of the objects 303 and 304 and between the virtual depth plane of the objects 304 and 305 is defined to be in the region of a few meters, the expedient virtual distance between the depth plane of the object 305 and the depth plane of the background 306 for a realistic image framework must expediently assume a magnitude is in the kilometer range, since, from experience, objects which are in the background are imaged with virtually no change in the case of minor differences in the viewing angle.

The two-dimensional original image is matched to the virtual image framework. In a schematic example shown in FIGS. 8a and 8b, this is done in such a way that the image data of the original image 301, in particular the image information in the individual pixels, is virtually assigned to the individual depth planes in the virtual image framework. This results in a virtual three-dimensional image model which, in the illustrated example here, is comparable to an arrangement of “theater stage flats”, in which the object 303 is located virtually at the same height as a first virtual depth plane from the foreground, and “conceals” the further “theater stage flats” of the objects 304 and 305, which are located at the levels of the corresponding other depth planes.

Smooth transitions between the individual virtual depth planes can additionally be achieved on the one hand by refining the grid of the graduations on the virtual distances between the individual depth planes and by introducing further graduations for the individual depth planes. On the other hand, it is also possible to suitably virtually deform the edges of the depth planes and/or of the objects which are located on the depth planes, such that they merge into one another. In the case of the schematic object 303 in FIG. 8a by way of example, it would be possible to virtually deform the edge of its depth plane such that the object 303 is provided with virtual spherical curvature. In a manner corresponding to this, the depth planes of the virtual image framework can be deformed such that the image information of the two-dimensional original image that is imaged on that may in principle have any desired shapes or distortions for the purposes of an expedient or desired virtual three-dimensional image model which either largely correspond to an effective three-dimensional body shape or else can be enriched with any desired artificial effects.

FIGS. 9a and 9b show a virtual three-dimensional image model 808 which has been generated from the virtual image framework shown in FIG. 8b, in the form of a section along the lines A-A and B-B from FIG. 8a, and their virtual recording from two viewing angles 351 and 352. The configuration illustrated in FIGS. 9a and 9b corresponds to a binocular view of a three-dimensional object, which is carried out in a virtual form within the method. In accordance with the perspective laws, the virtual three-dimensional objects 303, 304, 305 and 306 appear to have been shifted differently with respect to one another from the relevant virtual viewing angles 351 and 352. This perspective shift is the basis of the binocular or multi-ocular viewing of three-dimensional objects and is used in a virtual model form for the purposes of the method according to the invention.

FIG. 10 shows one example of a virtually generated shift under the influence of the virtual viewed projection from the virtual viewing angle 352 using the example of the detail of the virtual three-dimensional image model from FIG. 9a. Various methods can be used to calculate the virtual perspective shift of the virtual objects in the virtual three-dimensional image model. In the case of the method that is illustrated by way of example in FIG. 10, the principle of centric stretching is used, with the objects 303, 304 and 306 which are being looked at virtually from the viewing angle 352 being projected onto a virtual projection plane 308, and with their sizes being changed in the process. The projection plane can be located, in a virtual form, both in front of the virtual three-dimensional image model and behind the three-dimensional image model. A position of the virtual projection plane within the virtual three-dimensional image model, for example on a screen plane that is defined in the fix point definition, is likewise possible and is even highly expedient, since a projection such as this is the best way to represent binocular viewing conditions. In the case of the projection shown in FIG. 10, the viewing angle 352 at the same time forms a projection center, with the virtual three-dimensional image model being viewed so to speak using a virtual “reflected-light process”, in which the beam source coincides virtually with the camera.

Other virtual projection techniques can likewise be used and may be expedient. For example, the projection center can be arranged virtually behind the background of the virtual three-dimensional image model, with the corresponding objects in the virtual depth planes being projected as a “shadow outline” onto an expediently positioned projection plane, which is viewed from a viewing angle. In the case of a virtual projection such as this, those objects which are located in the virtual foreground are enlarged in comparison to the objects which are located virtually behind them, thus making it possible to produce an additional three-dimensional effect.

It is also possible to provide a plurality of virtual projection centers in conjunction with a plurality of virtual projection planes in any desired expedient combination. For example, the virtual background can thus be projected onto a first projection plane from a projection center which is arranged virtually a very long distance behind the virtual three-dimensional image model, while an arrangement of a large number of objects which are graduated very closely to one another are projected in the virtual foreground by means of a second projection center which does not produce any enlargement of these objects, but only a virtual shift of these objects.

The choice of the virtual projection mechanisms and the number of viewing angles depends on the specific individual case, in particular on the image picture in the two-dimensional original image, on the depth relationships interpreted in the original image, on the desired image effects and/or image effects to be suppressed and, not least, also on the computation complexity that is considered to be expedient and on the most recently used three-dimensional imaging method, for which the three-dimensional image pattern is intended to be produced. In principle, however, the virtual three-dimensional image model can be used to produce any desired number of perspective individual images with any desired number of virtual projection centers, virtual projection planes and viewing angles, etc. arranged as required, with the very simple exemplary embodiment that is illustrated in FIG. 10 indicating only a nonrepresentative embodiment option, which is only by way of example.

FIG. 11a shows a series of individual images 208a to 208d, which were generated in a virtual form using one of the projection methods described above, from a virtual three-dimensional image model of the original image 200 illustrated by way of example in FIG. 5a. Although the virtual individual images 208a to 208d are illustrated in a black and white form in this exemplary embodiment, they are generally coloured. Different deformation of this image section can be seen in the individual images 208a, 208b, 208c and 208d in particular by comparison of the structure of the flower illustrated in the upper part of the image. This is a result of the virtual projection of the virtual three-dimensional image model for the respective virtual viewing angles, of which there are four in this exemplary embodiment.

FIG. 11 shows a three-dimensional image pattern 209 which has been combined from the virtual individual images 208a, 208b, 208c and 208d for an imaging method with a three-dimensional impression in conjunction with an enlarged image detail 211 of the upper central image part from the three-dimensional image pattern 209. The three-dimensional image pattern 209 is combined from the individual images 208a-d using a for the respectively used imaging method with a depth effect.

Examples of two-dimensional image patterns and of their imaging by means of a monofocal lens array will be described in the following text with reference to FIGS. 12a and 12b, and FIGS. 13a to 13c, respectively.

FIG. 12a shows an example of a two-dimensional original image 200 which is subdivided into a series of image sections 361. The size of the individual image sections is in principle unrestricted and is governed essentially by the average size of the smallest closed image objects and of the individual pixels. On the assumption that image structures which can be recognized clearly are located in the image foreground, these must expediently be recorded essentially as a unit by the image sections in order that they can be distinguished from other structures and offer an adequate accommodation stimulus to the viewing eye. This means that accommodation stimuli can be created for an increasing number of details as the graduation becomes increasingly small, leading to the viewer being provided with a depth impression, provided that the individual pixels, that is to say the image pixels, are not emphasized in this process.

FIG. 12a shows a grid in the form of a matrix composed of essentially square image sections. However, the two-dimensional original image 200 may easily be subdivided in other ways. Inter alia, circular image sections, which are not illustrated here, arranged hexagonally are expedient. The hexagonal arrangement of circular image sections offers the advantage that a given image section has six immediate neighbors in comparison to the image subdivision in the form of a matrix, thus providing a more homogeneous transition for the accommodating eye from a first image section to the area closely surrounding that image.

The image sections 361 may include preprocessed image data, in particular image data which has been scaled, rotated or else mirrored about a plurality of axes, produced in advance in particular with respect to compensation for the imaging effect of the lens array. In this case, the image sections form a mosaic which is actually present on the two-dimensional image pattern. As can also be seen from FIG. 12a, some of the image sections 361a include image information which predominantly has little structure, while some of the other image sections 361b are particularly rich in structure.

In the example illustrated in FIG. 12a, the grid of the image sections is, however, initially not actually located in the image pattern itself, and is apparent only by means of the lens array located above it. An exemplary arrangement for this purpose is illustrated in the form of a side view in FIG. 12b. The two-dimensional image pattern appears on a display surface 370, for example the fluorescent surface of a cathode ray tube or the liquid-crystal matrix of a flat screen, and is viewed through a display surface 375. The monofocal lens array 360 is arranged on the display surface 375 and, for example, may be in the form of a transparent sheet, which contains a series of Fresnel lenses or zone plates arranged hexagonally or like a matrix. The sheet itself firmly adheres to the display surface by means of adhesive forces, electrostatic forces or a transparent adhesive film. Each lens element 365 of the lens array images an image section 361 located underneath it in such a way that it appears in front of or behind the image plane of the display 370 as a result of the enlargement produced in this process. The lens elements 365 are thus designed such that the display surface is located either shortly in front of or behind the individual focal points of the lens array.

This is illustrated in more detail in FIGS. 13a to 13c. The figures show an example of an image detail 200a from the two-dimensional original image 200 shown in FIG. 12a, with the changes to the image detail produced by the lens array 360 and the local lens elements.

The image detail 200a is formed by an unchanged part of the two-dimensional original image 200 from FIG. 12a, which is displayed on the display 370. In FIG. 13b, the image detail 200a is subdivided by an arrangement comprising, for example, four image sections 361. In this case, the two image sections 361a on the left each contain diffuse image background information, with relatively little structure, while the right-hand image sections 361 show a content which is rich in structure and is obviously located in the image foreground.

As is illustrated by way of example in FIG. 13c, each of these image sections is image enlarged by a lens element 365. In the illustration shown by way of example in FIG. 13c, the magnification factor when using a lens element with a focussing effect 365 is about 1:2. In this illustrative example, the left-hand image parts 361a which contain a diffuse image background with little structure result in little accommodation stimulus because of their lack of structure, even when magnified by the lens array, while the two image sections 361b on the right-hand side of FIG. 13c contain structures which result in accommodation of the eye to the image contents displayed in this way. This results in the image contents of the right-hand image sections 361b from FIG. 13c appearing to the viewer to be considerably closer than the contents of the left-hand image sections 361a. With an expedient size of the individual image sections 361, the gaps which are generated by the lens array during the imaging process are compensated for and integrated by the method of operation of the physiological visual perception apparatus.

In the exemplary embodiment shown in FIGS. 13a to 13c, the imaging of the image sections 361 leads to a horizontally and vertically mirrored display. In principle, there are two possible ways to counter this effect. In a first procedure, the individual image sections of the two-dimensional original image pattern are processed following the image processing method mentioned above, in particular by being scaled and horizontally or vertically mirrored, such that their imaging once again leads back to the original, initial image. The intensity of the preparatory scaling or mirroring operations is derived on the basis of the magnification factor of the lens array and on the basis of the position of the objects to be displayed as derived from the virtual three-dimensional image model, and this is applied to the image sections in advance.

In a second option which can be used in particular for simple image pictures, such as characters or simple geometric structures on a uniform image background, the number, arrangement and size of the lens elements in the lens array are chosen such that the imaging factors are not significant for the entire image. This embodiment in particular offers the advantage that, in some cases, there is no need for computation-intensive image preparatory work, and the three-dimensional image pattern can be recognized without any problems without a lens array. The image 200 without a monofocal lens array acts as a normal two-dimensional image, while the use of the lens array results in it appearing with a staggered depth effect, in which case the depth effect can be produced just by fitting the lens array, that is to say with very simple means.

### LIST OF REFERENCE SYMBOLS

10 Original image data
20 Read the original image data
30 Adapt the original image data
40 Temporary store the adapted original image data
50 Temporary stored image data
60 Optional colour channel/colour distribution change
70 Convert to grey-scales
80 Edge recognition method
81 Image pixel data
82 Select the image pixel
83 Read the brightness value of the image pixel
84 Increase the brightness value
85 Image pixel with increased brightness value
86 Reduce the brightness value
87 Image pixel with reduced brightness value
88 Go to: next pixel
89 Image menu for edge recognition
90 Soft drawing procedure
100 Optionally: tonal value correction
110 Fix point definition
120 Optionally: set further fix point options
130 Store the grey-scale mask
140 Grey-scale mask that is produced
150 Distort the original image texture, produce the virtual three-dimensional image model, produce virtual individual images
160 Virtual individual images
170 Combination of the virtual individual images
180 Image data for three-dimensional imaging method
200 Example of a two-dimensional original image
200a Image detail
208a First virtual individual image
208b Second virtual individual image
208c Third virtual individual image
208d Fourth virtual individual image
209 Combined three-dimensional image pattern
209a Enlarged detail of a combined three-dimensional image pattern
210 Example of an edge-marked image
220 Example of an edge-marked, soft-drawn image
230 Example of a tonal-value-corrected soft-drawn image
239 Fix point definition menu
240 Fix-point-defined image
241 Histogram
242 Grey-scale strip
243 Indicator pointer
244 Selection indicator
245 Direction selection for brightness values
301 Original image, schematic
303 First object
304 Second object
305 Third object
306 Assumed background
307 Virtual image framework with virtual depth planes
308 Virtual individual image
351 First virtual viewing point with first viewing angle
352 Second virtual viewing point with first viewing angle
360 Monofocal lens array
361 Image section
361a Image sections with little structure
361b Image sections rich in structure
365 Lens element
370 Display
375 Display surface

1. Method for production and display of a three-dimensional image pattern for imaging methods with three-dimensional depth effects from two-dimensional image data, in particular of image data from images, image sequences, video films and two-dimensional original images of this type,
characterized in that
a virtual three-dimensional image framework (307) which is based on a supposition-based three-dimensional image depth graduation is generated on the basis of image information determined from monocular original image data (10),
the original image data is matched to the virtual three-dimensional image framework (307) in order to generate a virtual three-dimensional image model (150), and
the data of the virtual three-dimensional image model is used as a pattern for production of the three-dimensional image pattern (209, 209a).

2. Method according to claim 1,
characterized in that
a method for edge recognition (80) of the imaged objects with generation of an edge-marked image (210) is carried out on the monocular original image data (10) in order to determine the image information, with various original image areas being associated on the basis of a determined multiplicity of edges with different virtual depth planes, in particular with a background and/or a foreground.

3. Method according to claim 1,
characterized in that
a method for determination of the colour information of given original image areas is carried out on the original image data (10) in order to determine the image information, with at least one first identified colour information item being associated with a first virtual depth plane, and a second colour information item being associated with a second virtual depth plane in the supposition-based image depth graduation.

4. Method according to claim 1,
characterized in that
the method for edge recognition (80) and the method for determination of the colour information are carried out individually and independently of one another, or in combination.

5. Method according to claim 1,
characterized in that
a soft drawing method (90, 220) is applied to the edge-marked image (210) for amplification and uniformity of an original image area which is rich in edges.

6. Method according to claim 1,
characterized in that
a tonal value correction (100) is optionally carried out on the edge-marked image (210).

7. Method according to claim 1,
characterized in that
a relevant image section is associated, based on the tonal value of one pixel, with a virtual depth plane (303, 304, 305, 306, 307) on the basis of the soft-drawn and/or additionally tonal-value-corrected, edge-marked image (210, 220).

8. Method according to claim 1,
characterized in that
the colour and/or tonal values are limited to a predetermined value and a virtual rotation point is defined for the virtual individual views that will be generated later, for a fix point definition (110).

9. Method according to claim 1,
characterized in that
a fixed predetermined virtual depth plane (303, 304, 305, 306, 307) is optionally associated with a predetermined colour and/or brightness value of an image pixel.

10. Method according to claim 1,
characterized in that
a fixed predetermined virtual depth plane is associated with defined image sections, in particular the image edge and/or the image center.

11. Method according to claim 1,
characterized in that,
in order to generate the virtual three-dimensional image model, the virtual three-dimensional image framework (307) is generated as a virtual network structure deformed in accordance with the virtual depth planes (303, 304, 305, 306, 307), and the two-dimensional original image is matched, as a texture, to the deformed network structure using a mapping method.

12. Method according to claim 1,
characterized in that
a range of virtual individual images (208a, 208b, 208c, 208d, 308) which reproduce the views of the virtual three-dimensional image model and in which those image sections of the original image (200, 301) which correspond to a defined depth plane are shifted and/or distorted in accordance with the virtual viewing angle are generated from a range of virtual observation angles (351, 352) from the virtual three-dimensional image model.

13. Method according to claim 1,
characterized in that
the virtual individual images (208a, 208b, 208c, 208d, 308) are combined in order to generate a three-dimensional image pattern (209, 209a), using an algorithm which is suitable for the imaging method and has an additional three-dimensional effect.

14. Method according to claim 1,
characterized in that
individual image areas of the original image are processed in order to produce the three-dimensional image pattern (209, 209a), in particular with scaling and/or rotation and/or mirroring being carried out, and the three-dimensional image pattern which is generated in this way is displayed by means of a monofocal lens array (360) located above it.

15. Method according to claim 14,
characterized in that
the two-dimensional original image (200) is displayed by means of the monofocal lens array (360) without image processing, with the two-dimensional original image (200) forming the three-dimensional image pattern for display by means of the monofocal lens array.

16. Apparatus for displaying a three-dimensional image pattern,
characterized by
a two-dimensional original image (200) as the two-dimensional image pattern, and a monofocal lens array (360) which extends above the image pattern.

17. Apparatus according to claim 16,
characterized in that
the two-dimensional image pattern is formed from a mosaic composed of image sections (361, 361a, 361b) which are associated with the array structure of the lens array (360), with essentially in each case one image section being an imaging object for essentially in each case one lens element (365) in the monofocal lens array.

18. Apparatus according to claim 16,
characterized in that,
in a first embodiment, the image sections (361, 361a, 361b) are essentially unchanged image components of the two-dimensional image pattern (200).

19. Apparatus according claim 16,
characterized in that,
in a further embodiment, the image sections (361, 361a, 361b) are scaled and/or mirrored and/or rotated in order to compensate for the imaging effects of the lens array (360).

20. Apparatus according to claim 16,
characterized in that
the two-dimensional image pattern (200) is an image which is generated on a display (370), and the lens array (360) is mounted on the surface (375) of the display.

21. Apparatus according to claim 16,
characterized in that
the lens array (360) is in the form of a Fresnel lens arrangement which is like a grid and adheres to the display surface.

22. Apparatus according to claim 16,
characterized in that
the lens array (360) is in the form of a zone-plate arrangement which is like a grid and adheres to the display surface.

23. Apparatus according to claim 16,
characterized in that
the lens array (360) is in the form of a conventional convex-lens arrangement which is like a grid and adheres to the display surface.
